(19) United States
(12) Patent Application Publication
(10) Pub. No.: US 2023/0167832 A1
(43) Pub. Date: Jun. 1, 2023

(54) EXHAUST GAS TURBOCHARGER WITH A SILENCER

(71) Applicant: TURBO SYSTEMS SWITZERLAND LTD., Baden (CH)

(72) Inventors: Christoph MATHEY, Fislisbach (CH); Carsten SPINDER, Rheinfelden (DE); Bernd ALBIEZ, Rickenbach (DE); Detlef BEHRENDT, Rheinheim (DE)

(21) Appl. No.: 17/997,418

(22) PCT Filed: Apr. 21, 2021
(86) PCT No.: PCT/EP2021/060396

§ 371 Date: Oct. 28, 2022

(30) Foreign Application Priority Data
Apr. 29, 2020 (EP) 20172097.6

(51) Int. Cl. F04D 29/66; F02C 6/12; F02C 7/045; F02M 35/10; F02M 35/12; F04D 29/42; F04D 29/44

(52) U.S. Cl. CPC F04D 29/664; F02C 6/12; F02C 7/045; F02M 35/10157; F02M 35/1272; F04D 29/4213; F04D 29/441; F05D 2220/40

(57) ABSTRACT

The invention relates to an exhaust gas turbocharger with a silencer. The silencer comprises a multiplicity of damping elements which are arranged concentrically about a central axis of the silencer and are spaced apart concentrically from one another, with the result that a flow duct is formed in each case between adjacent damping elements. The flow duct has an inlet which is at a greater radial spacing from the central axis than an outlet of the flow duct.

### TECHNICAL FIELD

The invention relates to the field of exhaust gas turbochargers for pressure-charged internal combustion engines. In particular, the invention relates to a silencer for an exhaust gas turbocharger of an internal combustion engine. The invention furthermore relates to an exhaust gas turbocharger having a silencer described in the present disclosure and to an internal combustion engine having such an exhaust gas turbocharger.

### TECHNICAL BACKGROUND

Exhaust gas turbochargers are nowadays used as standard to boost the power of internal combustion engines. An exhaust gas turbocharger typically comprises a turbine in the exhaust tract of the internal combustion engine and a compressor upstream of the internal combustion engine. Here, the exhaust gases of the internal combustion engine are expanded in the turbine. The work thus obtained is transferred by means of a shaft to the compressor, which compresses the air fed to the internal combustion engine. By using the energy of the exhaust gases to compress the air fed to the combustion process in the internal combustion engine, it is possible to optimize the combustion process and the efficiency of the internal combustion engine.

During operation of the exhaust gas turbocharger, sound waves of undesirably high amplitude typically occur predominantly in the compressor impeller, and these are released to the environment through the air intake duct. These sound waves are therefore usually damped by means of a silencer, in particular a filter silencer.

The prior art discloses filter silencers which are typically used on the intake side of a compressor which compresses the combustion air and feeds it to an internal combustion engine. A compressor of this kind is driven by the exhaust turbine of an exhaust gas turbocharger.

The filter silencers are usually designed in such a way that ambient air can be introduced through a filter arranged on the circumference of a filter silencer into a filter silencer interior fitted with damping elements, then flows past the damping elements and, in the process, is deflected by guide elements to the compressor impeller, from which sound waves emanate counter to the air flow. The sound damping is accomplished by dissipation at the damping elements, in that the sound energy is converted directly into heat by porous or fibrous absorber materials, from which the damping elements are substantially constructed. The absorber materials are usually held in shape and protected from the flow by an acoustically transparent envelope. This envelope can consist entirely or partially of metallic materials.

It has been found that with the filter silencers known from the prior art, in which the intake air is drawn in radially through an annular area, and is guided radially by means of curved inserts and is subsequently deflected axially with respect to the outlet of the silencer, optimum silencing has not yet been achieved, and unwanted flow and pressure losses occur.

Furthermore, it has been found that unwanted flow and pressure losses occur in the case of conventional filter silencers.

### BRIEF DESCRIPTION OF THE INVENTION

It is the object of the present invention to provide a silencer which is improved at least with regard to one of the abovementioned disadvantages of the filter silencers known from the prior art. In particular, it is an object of the present invention to provide a silencer for an exhaust gas turbocharger which, in comparison with the filter silencers known from the prior art, has an improved design, in particular for minimizing flow and pressure losses.

To achieve the abovementioned object, a silencer for an exhaust gas turbocharger as claimed in the independent claim is provided. Further aspects, advantages and features of the present invention can be found in the dependent patent claims, the description and the accompanying figures.

According to one aspect of the invention, a silencer for an exhaust gas turbocharger is provided which comprises a multiplicity of damping elements, which are arranged concentrically around a central axis of the silencer and are spaced apart concentrically from one another, with the result that a flow duct is formed in each case between adjacent damping elements. The damping elements comprise a nonmetallic material. In particular, the damping elements comprise one or more absorber materials made of a nonmetallic material. Furthermore, the damping elements can comprise an envelope made of a nonmetallic material. The flow duct has an inflow opening which is at a greater radial distance from the central axis than an outflow opening of the flow duct.

Thus, a silencer which is improved over the silencers known from the prior art is advantageously provided for an exhaust gas turbocharger. In particular, the silencer according to the invention provides a silencer with which flow and pressure losses can be reduced. In this way, a silencer having improved damping properties can be provided.

According to another aspect of the invention, an exhaust gas turbocharger with a silencer according to one of the embodiments described herein is provided, the silencer being arranged on the intake side of a compressor, in particular a radial compressor, of the exhaust gas turbocharger. In particular, the silencer described herein is advantageously configured in such a way that the silencer can be connected to a radially inner housing region of a compressor housing, wherein, in the mounted state, the silencer is at least partially surrounded by a radially outer housing region of the compressor housing.

According to another aspect of the invention, an internal combustion engine with an exhaust gas turbocharger described herein is provided. The exhaust gas turbocharger comprises a silencer according to embodiments described herein, which is arranged on the intake side of a compressor, in particular a radial compressor, of the exhaust gas turbocharger. The exhaust gas turbocharger is more advantageously configured in such a way that the exhaust gas turbocharger can be connected to an internal combustion engine in a vertical or horizontal orientation via one or more exhaust lines and one or more charge air outlet openings.

### BRIEF DESCRIPTION OF THE FIGURES

The invention will be explained below with reference to exemplary embodiments, which are illustrated in the figures and from which further advantages and modifications can be derived. Here:

FIG. 1 shows a schematic sectional view of a silencer according to embodiments described herein, which is arranged on an intake side of a compressor;

FIG. 2 shows a schematic axial front view of a silencer according to embodiments described herein; and

FIG. 3 shows a schematic perspective view of an exhaust gas turbocharger having a silencer according to embodiments described herein.

### DETAILED DESCRIPTION OF THE FIGURES

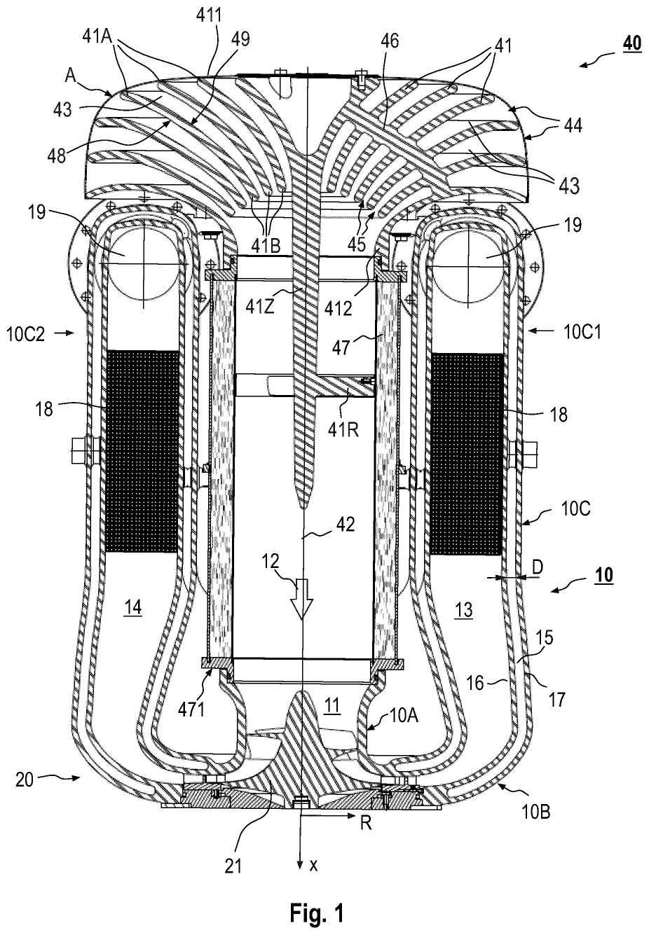

A silencer 40 for an exhaust gas turbocharger according to the present disclosure is described with reference to FIG. 1. FIG. 1 shows a schematic sectional view of the silencer 40, which is arranged on an intake side of a compressor, in particular a radial compressor 20.

According to one embodiment, which can be combined with other embodiments described herein, the silencer 40 comprises a multiplicity of damping elements 41. As illustrated by way of example in FIG. 1, the damping elements 41 are arranged concentrically around a central axis 42 of the silencer. Furthermore, the damping elements 41 are spaced apart concentrically from one another. In other words, the damping elements 41 are arranged spaced apart from one another in the radial direction R. As illustrated by way of example in FIG. 1, the damping elements 41 are designed and arranged in such a way that a respective flow duct 43 is formed in each case between adjacent damping elements 41. The flow duct 43 has an inflow opening 44 which is at a greater radial distance from the central axis 42 than an outflow opening 45 of the flow duct 43. The damping elements 41 comprise a nonmetallic material. In particular, the damping elements 41 can consist of a nonmetallic material.

Accordingly, a silencer which is improved over the silencers known from the prior art is advantageously provided for an exhaust gas turbocharger. In particular, flow and pressure losses can be reduced with the embodiments of the silencer which are described herein. Furthermore, a low-cost silencer can be provided by using a nonmetallic material. The use of a nonmetallic material can also lead to improved sound damping. In addition, the design of the silencer can be better adapted to the requirements of the application. In particular, the silencer can be of smaller construction, thereby making it less expensive.

According to one embodiment, which can be combined with other embodiments described herein, the nonmetallic material comprises at least one material selected from the group comprising: polymers, in particular inorganic polymers; polymer-based materials, in particular polymer-based composites; ceramic materials, in particular materials comprising ceramic hollow spheres; glass fiber materials, in particular absorber materials based on glass fiber; glass fiber materials comprising SiO₂ silicate fibers; and glass foam materials. Thus, the damping elements 41 can consist of one or more of the nonmetallic materials listed herein, or can comprise one or more of the nonmetallic materials listed herein.

As can be seen from FIG. 1, the arrangement of the flow ducts of the silencer described herein differs from the flow duct arrangement of conventional silencers in that the flow ducts of the silencer described herein are of concentric design. In contrast, conventional silencers for exhaust gas turbochargers are typically configured in such a way that the damping elements are arranged around a central axis in the circumferential direction, wherein flow ducts are formed between the damping elements, with the result that their outflow openings are directed substantially perpendicularly to the central axis. As illustrated in FIG. 1, the flow ducts of the silencer described herein are configured in such a way that their outflow openings provide an outflow direction which has a radial and a positive axial flow component.

According to one embodiment, which can be combined with other embodiments described herein, the damping elements 41 are arranged in the manner of a funnel around the central axis 42, as illustrated by way of example in FIG. 1. In the present disclosure, a “funnel-like damping element” can be understood to mean that the damping element has a shape of a truncated cone, wherein the truncated cone has a central opening that extends from the truncated cone base surface to the truncated cone top surface and tapers in the process. The circumferential surface of the truncated cone can be curved. The radially outwardly facing flow surfaces 48 of the damping element which are illustrated in FIG. 1 are, for example, concavely curved circumferential surfaces.

According to one embodiment, which can be combined with other embodiments described herein, the damping elements 41 are curved between an inflow end 41A and an outflow end 41B, with the result that the flow duct 43 is designed in such a way as to provide a flow deflection in the direction of the central axis 42. As shown by way of example in FIG. 1, radially outwardly facing flow surfaces 48 of the damping elements 41 typically have a concave curvature. Radially inwardly facing flow surfaces 49 of the damping elements 41 typically have a convex curvature.

In particular, the flow deflection provided by the flow ducts can comprise a deflection of the flow by a deflection angle α of 5°≤α≤180°, in particular 15°≤α≤180°. In the present disclosure, the term “deflection angle” can be understood to mean the angle which results between a main inflow direction of an inflow opening 44 of a flow duct 43 and a main outflow direction of an outflow opening 45 of the flow duct 43.

As illustrated by way of example in FIG. 1, the respective deflection angles of the respective flow ducts can increase in the radial direction R. In other words, flow ducts which are arranged radially further outward typically provide a larger deflection angle than flow ducts which are arranged radially further inward.

According to one embodiment, which can be combined with other embodiments described herein, the flow ducts (also referred to as guide rib ducts) are configured in such a way that the speed of flow is as constant as possible and no speed peaks occur. This is advantageous, in particular, because the contribution of speed peaks to the pressure loss is squared, with the result that the silencer described herein has a reduced pressure loss. A reduction in the pressure loss advantageously has a positive effect on the damping behavior of the silencer, thus enabling the damping behavior of the silencer described herein to be improved.

According to one embodiment, which can be combined with other embodiments described herein, inflow ends 41A of the damping elements 41 lie on a surface A which is convexly curved in the axial direction x. For example, the convexly curved surface A can be a partially spherical or partially elliptical surface. Typically, a perforated plate 411 or a filter element of the kind illustrated by way of example in FIG. 1 is arranged on the convexly curved surface A.

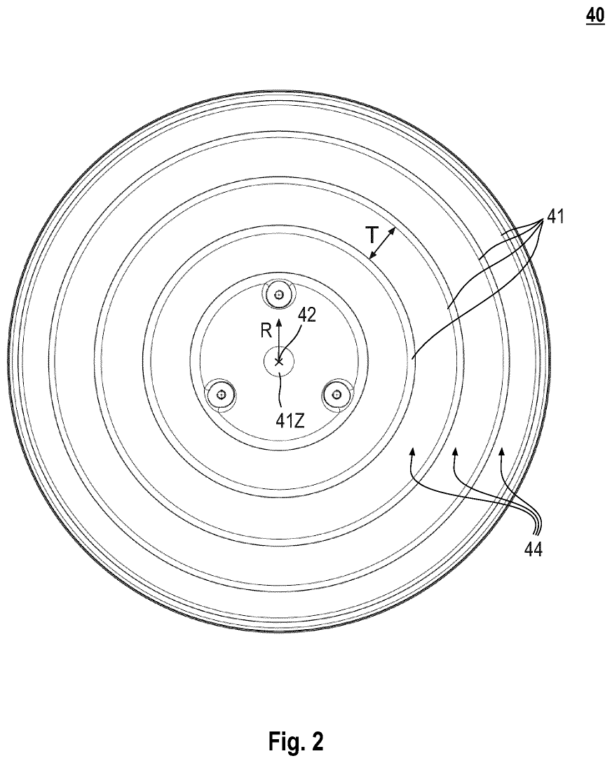

According to one embodiment, which can be combined with other embodiments described herein, the inflow opening 44 of the respective flow ducts has a larger flow cross section than the outflow opening 45 of the respective flow ducts. As illustrated by way of example in FIG. 2, the inflow opening 44 of the respective flow ducts 43 can be formed in the manner of a ring around the central axis 42. Furthermore, a distance T between adjacent damping elements 41 is illustrated by way of example in FIG. 2. The distance T between adjacent damping elements 41 can increase, decrease or be constant in the radial direction R.

In this context, it should be noted that the outflow opening 45 of the respective flow ducts 43 can also be formed in the manner of a ring around the central axis 42.

According to one embodiment, which can be combined with other embodiments described herein, the silencer further comprises a connecting structure 46 for connecting at least two adjacent damping elements 41. Typically, the connecting structure 46 is designed to improve the stability of the silencer. The connecting structure 46 can be provided by webs between the damping elements, for example. The connecting structure can comprise a nonmetallic material or consist of a nonmetallic material. For example, the connecting structure 46 can comprise or consist of at least one nonmetallic material selected from the group comprising: polymers, in particular inorganic polymers; polymer-based materials, in particular polymer-based composites; ceramic materials, in particular materials comprising ceramic hollow spheres; glass fiber materials, in particular absorber materials based on glass fiber; glass fiber materials comprising SiO₂ silicate fibers; and glass foam materials. Thus, the connecting structure 46 can consist of one or more of the nonmetallic materials listed herein, or can comprise one or more of the nonmetallic materials listed herein.

According to one embodiment, which can be combined with other embodiments described herein, the silencer further comprises a cylindrical damping structure 47 on the outflow side. For example, the cylindrical damping structure 47 can be connected to an outflow end of the radially outermost damping element 412. In this way, the damping properties of the silencer can be additionally improved.

According to one embodiment, which can be combined with other embodiments described herein, the damping structure 47 comprises a nonmetallic material or consists of a nonmetallic material. For example, the damping structure 47 can comprise or consist of at least one nonmetallic material selected from the group comprising: polymers, in particular inorganic polymers; polymer-based materials, in particular polymer-based composites; ceramic materials, in particular materials comprising ceramic hollow spheres; glass fiber materials, in particular absorber materials based on glass fiber; glass fiber materials comprising SiO₂ silicate fibers; and glass foam materials. Thus, the damping structure 47 can consist of one or more of the nonmetallic materials listed herein, or can comprise one or more of the nonmetallic materials listed herein.

According to one embodiment, which can be combined with other embodiments described herein, the cylindrical damping structure 47 can have a connecting structure 471 for connecting the silencer to an intake side of a compressor housing 10 of an exhaust gas turbocharger 30. As shown in FIG. 1, the compressor housing 10 can be a compressor housing of a radial compressor 20, for example. The connecting structure 471 can be embodied as a connecting flange.

According to one embodiment, which can be combined with other embodiments described herein, the connecting structure 471 comprises a nonmetallic material or consists of a nonmetallic material. For example, the connecting structure 471 can comprise or consist of at least one nonmetallic material selected from the group comprising: polymers, in particular inorganic polymers; polymer-based materials, in particular polymer-based composites; ceramic materials, in particular materials comprising ceramic hollow spheres; glass fiber materials, in particular absorber materials based on glass fiber; glass fiber materials comprising SiO₂ silicate fibers; and glass foam materials. Thus, the connecting structure 471 can consist of one or more of the nonmetallic materials listed herein, or can comprise one or more of the nonmetallic materials listed herein.

A compressor housing 10 of a radial compressor 20 according to the present disclosure is described in more detail with reference to FIG. 1. According to one embodiment, which can be combined with other embodiments described herein, the compressor housing 10 comprises a radially inner housing region 10A, which forms an axial inflow duct 11 in an intake region of the radial compressor 20. Furthermore, the compressor housing 10 comprises a diffuser region 10B adjoining the radially inner housing region 10A. The diffuser region 10B is designed to deflect a radial flow downstream of a compressor impeller 21 in an axial direction counter to an inflow direction 12 of the inflow duct 11. Furthermore, the compressor housing 10 comprises a radially outer housing region 10C, which adjoins the diffuser region 10B, extends axially counter to the inflow direction 12 and provides one or more charge air collecting chambers 13, 14. Individual parts of the compressor housing, in particular the diffuser region 10B of the compressor housing, can be provided with a sound-absorbing lining using the nonmetallic materials described herein.

As illustrated by way of example in FIG. 1, the one or more charge air collecting chambers 13, 14 typically each comprise a charge air outlet opening 19. The charge air outlet opening is typically designed to provide outflow of the charge air in an outflow direction 23 which is transverse, in particular substantially at right angles, to the inflow direction 12.

In the exemplary embodiment illustrated in FIG. 1, the radially outer housing region 10C comprises a first charge air collecting chamber 13 and a second charge air collecting chamber 14. The first charge air collecting chamber 13 and the second charge air collecting chamber 14 are each connected to the diffuser region 10B, thus providing a first charge air housing leg 10C1 and a second charge air housing leg 10C2.

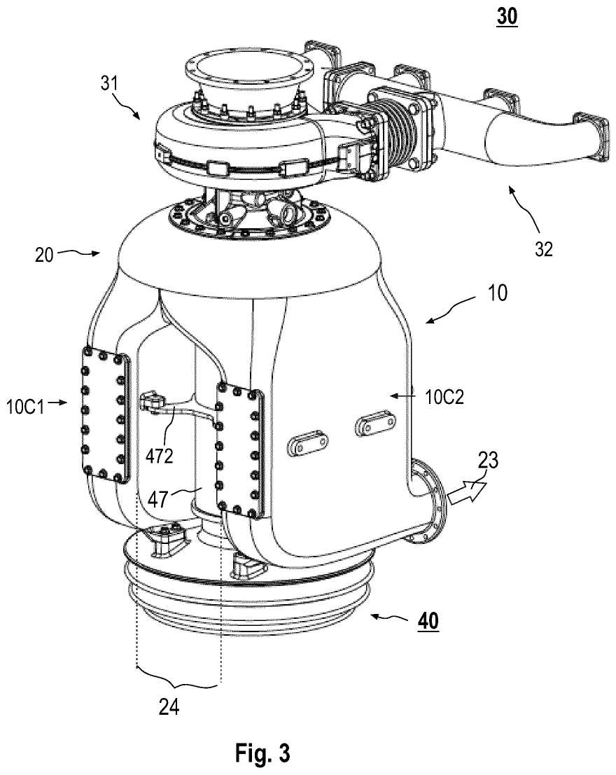

Typically, the radially outer housing region 10C has an axial extent in the opposite direction to the inflow direction 12 that is greater than an axial extent of the radially inner housing region 10A. Thus, the compressor housing is designed in such a way that the radially outer housing region 10C at least partially surrounds an axial interspace 24. The axial interspace 24, which typically lies between the first charge air housing leg 10C1 and the second charge air housing leg 10C2, is shown in FIG. 3. Typically, the axial interspace 24 is designed to receive, on the intake side, a cylindrical damping structure 47 of a silencer described herein. As illustrated by way of example in FIG. 1, the cylindrical damping structure 47 can be fastened to the radially outer housing region 10C by means of a fastening element 472.

In other words, the axial interspace 24 can be used for supplying air to the inflow duct 11 of the radial compressor. The supply of air can take place via a feed line, which can be designed as a cylindrical damping structure 47, for example. Such a sound-absorbing intake section can advantageously be used to achieve a reduction in the sound pressure level at the intake opening of the radial compressor. In this way, it is possible to use a silencer with lower sound absorption, which in turn has advantages in terms of pressure loss. This thus leads to a further reduction in losses and hence can contribute to an improvement in the efficiency of a radial compressor.

According to one embodiment, which can be combined with other embodiments described herein, at least one of the radially outer housing region 10C and the diffusor region 10B is of two-shell design, thus providing an interspace 15 through which a cooling medium can flow. In particular, the radially outer housing region 10C is typically embodied with two shells, and the diffuser region 10B is embodied at least partially or completely with two shells. For example, at least one, in particular both, of the radially outer housing region 10C and of the diffuser region 10B can comprise an inner shell 16 and an outer shell 17 spaced apart from the inner shell by a distance D, as illustrated by way of example in FIG. 1.

In this way, a compressor housing having integrated charge air cooling can advantageously be provided.

Furthermore, at least one charge air cooler 18, as illustrated by way of example in FIG. 1, can be provided in the one or more charge air collecting chambers 13, 14.

According to one embodiment, which can be combined with other embodiments described herein, the silencer 40 can further comprise a central elongate damping element 41Z. Typically, the central elongate damping element 41Z extends along the central axis and projects in the axial direction x beyond an outflow end of the radially outermost damping element 412. In particular, the central elongate damping element 41Z can be a pin-like damping element, as illustrated by way of example in FIG. 1. Typically, the central elongate damping element 41Z is arranged concentrically around the central axis 42 of the silencer. In this way, the damping properties of the silencer can be additionally improved.

As shown by way of example in FIG. 1, a bearing structure 41R can furthermore be provided for supporting the central elongate damping element 41Z. For example, the bearing structure 41R can comprise radial webs. Typically, the radial webs are connected at one end to the inner circumferential surface of the cylindrical damping structure and at an opposite end to the central elongate damping element 41Z. According to one example, the radial webs can have drop-shaped cross sections.

An exhaust gas turbocharger 30 with a silencer 40 according to the present disclosure is described with reference to FIG. 3. According to one embodiment, which can be combined with other embodiments described herein, the exhaust gas turbocharger 30 comprises a silencer 40 according to embodiments described herein, the silencer 40 being arranged on the intake side of a compressor, in particular a radial compressor 20, of the exhaust gas turbocharger. As can be seen by way of example from FIG. 3 in combination with FIG. 1, the silencer 40 can be connected to a radially inner housing region 10A of a compressor housing 10 and can be at least partially surrounded by a radially outer housing region 10C of the compressor housing 10.

Typically, the exhaust gas turbocharger 30 according to embodiments described herein is connected to an internal combustion engine in a vertical or horizontal orientation via one or more exhaust lines 32 and one or more charge air outlet openings 19. It is thus advantageously possible to provide an internal combustion engine having an exhaust gas turbocharger as described herein which can be connected to an internal combustion engine in a vertical or horizontal orientation via one or more exhaust lines and one or more charge air outlet openings.

As can be seen from the embodiments described herein, a silencer is advantageously provided which is improved over the filter silencers known from the prior art.

In particular, the silencer according to the invention provides a silencer with which flow and pressure losses can be reduced. In particular, the silencer according to the invention advantageously has a design and an arrangement of the damping elements with which pressure losses during flow through the silencer can be reduced, leading to improved damping properties.

### LIST OF REFERENCE SIGNS

10 compressor housing
10A radially inner housing region
10B diffuser region
10C radially outer housing region
10C1 first charge air housing leg
10C2 second charge air housing leg
11 inflow duct
12 inflow direction
13 first charge air collecting chamber
14 second charge air collecting chamber
15 interspace
16 inner shell
17 outer shell
18 charge air cooler
19 charge air outlet opening
20 radial compressor
21 compressor impeller
23 outflow direction of the charge air
24 axial interspace
30 exhaust gas turbocharger
40 silencer
41 damping elements
41A inflow end of the damping elements
41B outflow end of the damping elements
41Z central elongate damping element
41R bearing structure for supporting the central elongate damping element
411 perforated plate/filter element
412 radially outer damping element
42 central axis
43 flow duct
44 inflow opening
45 outflow opening
46 connecting structure
47 cylindrical damping structure
471 connecting structure
472 fastening element for fastening the sound-absorbing element to the radially outer housing region
48 radially outwardly facing flow surfaces
49 radially inwardly facing flow surfaces
31 turbine
32 exhaust line
R radial direction
x axial direction
T distance between adjacent damping elements
D distance between inner shell and outer shell
A convexly curved surface

1. An exhaust gas turbocharger with a silencer, which is arranged on the intake side of a compressor of the exhaust gas turbocharger, wherein the silencer comprises a multiplicity of damping elements, which are arranged concentrically around a central axis of the silencer and are spaced apart concentrically from one another, with the result that a flow duct is formed in each case between adjacent damping elements, wherein the damping elements comprise a nonmetallic material, and wherein the flow duct has an inflow opening which is at a greater radial distance from the central axis than an outflow opening of the flow duct, wherein the silencer comprises a cylindrical damping structure on the outflow side, wherein the cylindrical damping structure is connected to an outflow end of the radially outermost damping element of the multiplicity of damping elements, and wherein the silencer comprises a central elongate damping element which extends along the central axis and projects in the axial direction beyond an outflow end of the radially outermost damping element.

2. The exhaust gas turbocharger as claimed in claim 1, wherein the damping elements are arranged in the manner of a funnel around the central axis.

3. The exhaust gas turbocharger as claimed in claim 1, wherein the damping elements consist of a nonmetallic material.

4. The exhaust gas turbocharger as claimed in claim 1, wherein the nonmetallic material comprises at least one material selected from the group comprising: polymers polymer-based composites; ceramic materials glass fiber materials; glass fiber materials comprising SiO2 silicate fibers; and glass foam materials.

5. The exhaust gas turbocharger as claimed in claim 1, wherein the damping elements are curved between an inflow end and an outflow end, with the result that the flow duct is designed to provide a flow deflection in the direction of the central axis.

6. The exhaust gas turbocharger as claimed in claim 1, wherein radially outwardly facing flow surfaces of the damping elements have a concave curvature, and wherein radially inwardly facing flow surfaces of the damping elements have a convex curvature.

7. The exhaust gas turbocharger as claimed in claim 1, wherein inflow ends of the damping elements lie on a surface which is curved convexly in the axial direction.

8. The exhaust gas turbocharger as claimed in claim 1, wherein the inflow opening has a larger flow cross section than the outflow opening.

9. The exhaust gas turbocharger as claimed in claim 1, further comprising a connecting structure for connecting at least two adjacent damping elements, wherein the connecting structure comprises a nonmetallic material, wherein the nonmetallic material comprises at least one material selected from the group comprising: polymers polymer-based composites; ceramic materials; glass fiber materials; glass fiber materials comprising SiO2 silicate fibers; and glass foam materials.

10. The exhaust gas turbocharger as claimed in claim 1, wherein the cylindrical damping structure on the outflow side comprises a nonmetallic material, wherein the nonmetallic material comprises at least one material selected from the group comprising: polymers; polymer-based composites; ceramic materials; glass fiber materials; glass fiber materials comprising SiO2 silicate fibers; and glass foam materials.

11. (canceled)

12. The exhaust gas turbocharger as claimed in either of claim 10, wherein the cylindrical damping structure has a connecting structure for connecting the silencer to an intake side of a compressor housing of an exhaust gas turbocharger.

13. The exhaust gas turbocharger as claimed in claim 1, wherein the central elongate damping element is a pin-like damping element wherein the central elongate damping element comprises a nonmetallic material, wherein the nonmetallic material comprises at least one material selected from the group comprising: polymers polymer-based composites; ceramic materials; glass fiber materials; glass fiber materials comprising SiO2 silicate fibers; and glass foam materials.

14. The exhaust gas turbocharger as claimed in claim 1, wherein the compressor is a radial compressor, and wherein the silencer is connected to a radially inner housing region of a compressor housing, and is at least partially surrounded by a radially outer housing region of the compressor housing, wherein a diffuser region of the compressor housing is lined with sound-absorbing material.

15. An internal combustion engine having an exhaust gas turbocharger with a silencer, which is arranged on the intake side of a compressor of the exhaust gas turbocharger, wherein the silencer comprises a multiplicity of damping elements, which are arranged concentrically around a central axis of the silencer and are spaced apart concentrically from one another, with the result that a flow duct is formed in each case between adjacent damping elements, wherein the damping elements comprise a nonmetallic material, and wherein the flow duct has an inflow opening which is at a greater radial distance from the central axis than an outflow opening of the flow duct, wherein the silencer comprises a cylindrical damping structure on the outflow side, wherein the cylindrical damping structure is connected to an outflow end of the radially outermost damping element of the multiplicity of damping elements, and wherein the silencer comprises a central elongate damping element which extends along the central axis and projects in the axial direction beyond an outflow end of the radially outermost damping element.

16. The exhaust gas turbocharger as claimed in claim 5, wherein the flow deflection comprises a deflection of the flow by a deflection angle α of 5°≤α≤180°.

17. The exhaust gas turbocharger as claimed in claim 7, wherein the surface which is curved convexly in the axial direction is at least one of a partially spherical surface and a partially elliptical surface.

18. The exhaust gas turbocharger as claimed in claim 1, wherein at least one of the inflow opening and the outflow opening of the flow duct is formed in the manner of a ring around the central axis.

19. The exhaust gas turbocharger as claimed in claim 12, wherein the connecting structure is a connecting flange, and wherein the compressor housing is a compressor housing of a radial compressor.

20. The exhaust gas turbocharger as claimed in claim 14, wherein the sound-absorbing material is a nonmetallic material.

21. The internal combustion engine as claimed in claim 15, wherein the exhaust gas turbocharger is connected to the internal combustion engine in a vertical or horizontal orientation via one or more exhaust lines and one or more charge air outlet openings.
